(19) United States
(12) Patent Application Publication
(10) Pub. No.: US 2006/0236735 A1
(43) Pub. Date: Oct. 26, 2006

(54) Integrated hydrogen sulfide absorber system for making potassium-sulfur fertilizer

(75) Inventors: Dennis W. Johnson, Barberton, OH (US); Mark S. Ehrnschwender, Terrace Park, OH (US)

Correspondence Address: WOOD, HERRON & EVANS, LLP, 2700 CAREW TOWER, 441 VINE STREET, CINCINNATI, OH, 45202, US

(73) Assignee: EnviroSolv Energy LLC, Terrace Park, OH (US)

(21) Appl. No.: 11/114,790

(22) Filed: Apr. 26, 2005

(51) Int. Cl. C05D 9/00

(52) U.S. Cl. 71/31

(57) ABSTRACT

A method of scrubbing hydrogen sulfide (H₂S) from a gas stream employing a potassium-based sorbent to remove at least a portion of the H₂S. This results in reaction products that are oxidized and converted into potassium-sulfur based fertilizers. The potassium based sorbent may be potassium hydroxide (KOH) made on site from potash. Hydrogen chloride (HCI) may be a byproduct when the sorbent is made from potash.

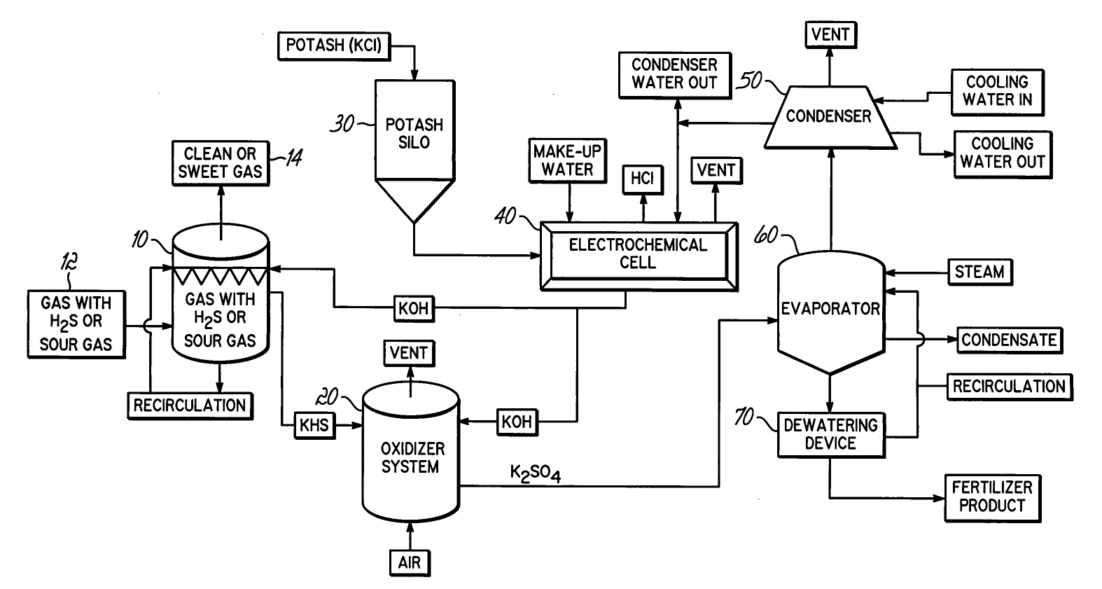

### FIELD OF THE INVENTION

The present invention relates to removal of hydrogen sulfide (H₂S) from gas streams, such as natural gas and combustion flue gases, and the production of potassium-sulfur fertilizers.

### BACKGROUND OF THE INVENTION

In the pollution control field, several approaches are used to remove hydrogen sulfide from natural gas (sour gas) and from gases produced by the burning of a fossil fuel in reducing environments such as is done by gasifiers, such as those that are used in the power, steel, and paper (including black liquor) industries, coking processes, and the like. Many water and wastewater treatment processes remove hydrogen sulfide (H₂S) removal for odor control.

One conventional approach for removal of H₂S involves the use of absorbing solutions such as complex amines, caustic soda, soda ash, and other strong alkali compounds. Another conventional approach involves removing H₂S with a Claus reactor in which part of the H₂S is oxidized to SO₂ and the remaining H₂S is reacted with the SO₂ across a catalyst to form sulfur. By and large, the most widely used approaches to removing hydrogen sulfide from gas involve these post-combustion clean up methods.

Major disadvantages of the conventional methods for H₂S removal are the cost and complexity of the processes, the high operating costs, including the cost of reagents, and the high cost of disposal of waste.

For these and other reasons, it is desirable to provide methods for removing H₂S from natural gas and gas streams, like flue gas streams, that overcome the various problems associated with conventional methods for removing H₂S.

### SUMMARY OF THE INVENTION

In accordance with an embodiment of the invention, a method of scrubbing hydrogen sulfide from a gas stream comprises contacting the gas stream with a potassium-based substance, such as potassium hydroxide, effective to remove the hydrogen sulfide from the gas stream as a reaction product and then converting the reaction product to a fertilizer based on potassium and sulfur. The potassium hydroxide may be produced on site from potassium chloride (KCI or potash).

A host of advantages are realized by practicing the methodology of the invention. One advantage is that a relatively high removal of H₂S is achieved. The methodology also results in the production of a high value potassium-sulfur based fertilizer and, optionally, hydrochloric acid.

The process permits many choices of reagents for H₂S control with potassium alkalis being the preferred reagents because of gas phase reactions in the removal stage, production of a potassium sulfate final product, and the ability to make the potassium alkali on site from potassium chloride.

These and other advantages of the present invention shall become more apparent from the accompanying drawings and description thereof.

### BRIEF DESCRIPTION OF THE DRAWING

The accompanying drawing, which is incorporated in and constitutes a part of this specification, illustrates embodiments of the invention and, together with a general description of the invention given above, and the detailed description given below, serves to explain the principles of the present invention

The Figure is a flow diagram in accordance with the present invention.

### DETAILED DESCRIPTION

A wet hydrogen sulfide scrubber, shown in the Figure and denoted by numeral 10, employs a properly designed absorber system employing mass transfer contact surfaces, sprays, trays, packing, and the like. The vessel of hydrogen sulfide scrubber 10 is designed to handle the pressure of a gas stream 12 containing hydrogen sulfide (H₂S) and made of properly selected corrosion resistant materials. This hydrogen sulfide scrubber 10 is designed to meet the H₂S removal requirements of a final clean or sweet gas stream 14 and is preferably adequate at removing H₂S up to 99% or higher.

The primary reaction that occurs in the hydrogen sulfide scrubber 10 uses potassium hydroxide (KOH) and is given by:

1) KOH+H₂S→KHS+H₂O
An oxidizer sub-system 20 of the hydrogen sulfide scrubber 10 receives the KHS from the hydrogen sulfide scrubber 10. In the oxidizer sub-system 20, a number of reactions take place depending upon the operating conditions. The partial oxidation reactions are:

2) 2KHS+2O₂→K₂S₂O₃+H₂O (potassium thiosulfate)

3) 2KHS+3O₂→2KHSO₃ (potassium bisulfite)

4) KHS+2O₂→KHSO₄ (potassium bisulfate)
The total oxidation reactions are summarized below. Each total oxidation reaction produces potassium sulfate with the addition of potassium hydroxide, potassium bicarbonate, potassium carbonate, or a mixture of two or more of these potassium-based substances, but potassium hydroxide would be used most often:

5) KHS+2O₂+KOH→K₂SO₄+H₂O

6) KHS+2O₂+KHCO₃→K₂SO₄+H₂O+CO₂↑

7) 2KHS+K₂CO₃+4O₂→2K₂SO₄+H₂O+CO₂↑

The potassium hydroxide, potassium bicarbonate, or potassium carbonate may be purchased, but these compounds may be relatively expensive. Therefore, the invention preferably uses potassium hydroxide produced at the site of the hydrogen sulfide scrubber 10 from potash (potassium chloride or KCI), which is relatively inexpensive by comparison. The potash, which is stored in potash silo 30, may be split in an electrochemical cell 40 by a process known to a person of ordinary skill in the art. The electrochemical cell 40 may use electrical energy to split KCI, in the presence of water, into KOH and HCI. These products are separated using membranes from the electrochemical cell 40. The HCI from the electrochemical cell 40 is sold as a product or otherwise used elsewhere. The KOH from the electrochemical cell 40 may be used in the hydrogen sulfide scrubber 10 and in the oxidizer system 20. Other conventional methods known to persons of ordinary skill in the art may be used for converting the potash to KOH.

The conditions required to oxidize potassium hydrogen sulfide would include using high pressure air or oxygen, controlling operating parameters, including pH, feed rates, etc., and the use of catalysts, especially metals like cobalt, iron, etc., when required. It should be noted that for high pressure applications like sour gas processing, the solution from the hydrogen sulfide scrubber 10 may need to be introduced into a flash system (not shown) to reduce the pressure and remove entrained natural gas prior to the oxidation step 20.

The reaction product of the H₂S reactions may include potassium thiosulfate, bisulfite, bisulfate, and/or sulfate. This reaction product may be concentrated and dried by any conventional method appreciated by a person of ordinary skill in the art to produce a high value fertilizer product. One conventional method of concentrating and drying employs an evaporator 60 that uses the energy from steam to remove water. The concentrated product is then dewatered by an appropriate dewatering device 70, such as a vacuum filter, centrifuge, pressure filter, or the like. The concentrated and dried product may be combined with other ingredients, such as other fertilizers, pesticides, herbicides, micronutrients, minerals, etc. and combinations of these ingredients, to make a blended high value fertilizer. This combination of ingredients could be simply a blend or could be an improved fertilizer in the form of a pellet, granule, or other such particle made by known mechanical methods (not shown).

A condenser 50 is used to separate and collect water from the outlet of evaporator 60. The condensed water from condenser 50 is returned to the process for use. The condenser 50 reduces the amount of fresh make-up water required by the process.

While the present invention has been illustrated by a description of various preferred embodiments and while these embodiments have been described in considerable detail in order to describe the best mode of practicing the invention, it is not the intention of applicants to restrict or in any way limit the scope of the appended claims to such detail. Additional advantages and modifications within the spirit and scope of the invention will readily appear to those skilled in the art. The invention itself should only be defined by the appended claims, wherein we claim:

1. A method of scrubbing a gas stream containing hydrogen sulfide, comprising:
contacting the gas stream with a potassium-based substance effective to remove hydrogen sulfide from the gas stream as a reaction product; and
converting the reaction product to a potassium-sulfur based fertilizer.

2. The method of claim 1 wherein converting the reaction product further comprises:
oxidizing the reaction product to form the potassium-sulfur based fertilizer.

3. The method of claim 1 wherein the potassium-based substance is selected from a group consisting of potassium hydroxide, potassium carbonate, potassium bicarbonate, and combinations thereof.

4. The method of claim 1 wherein the potassium-based substance is potassium hydroxide, and further comprising:
making the potassium hydroxide from potassium chloride.

5. The method of claim 4 wherein a hydrogen chloride product is produced when potassium hydroxide is made from potassium chloride.

6. The method of claim 1 wherein the potassium-sulfur based fertilizer is selected from the group Including potassium sulfate compounds, potassium thiosulfate compounds, potassium bisulfite compounds, potassium bisulfate compounds, and combinations thereof.

7. The method of claim 1 further comprising:
drying the potassium-sulfur based fertilizer.

8. The method of claim 7 further comprising:
combining the dried potassium-sulfur based fertilizer with additional ingredients selected from the group consisting of other fertilizers, pesticides, herbicides, minerals, micronutrients, and combinations thereof.

9. The method of claim 8 further comprising:
mechanically forming the dried potassium-sulfur based fertilizer into a pellet, granule, or other such particle.

10. The method of claim 7 further comprising: mechanically forming the dried potassium-sulfur based fertilizer and added ingredients into a pellet, granule, or other such particles.
